(19) United States
(12) Patent Application Publication
(10) Pub. No.: US 2010/0161996 A1
(43) Pub. Date: Jun. 24, 2010

(54) System and Method for Developing Computer Chips Containing Sensitive Information

(76) Inventors: Douglas L. Whiting, Carlsbad, CA (US); Raymond R. Savarda, Wake Forest, NC (US)

Correspondence Address: NYDEGGER & ASSOCIATES, 348 OLIVE STREET, SAN DIEGO, CA, 92103, US

(21) Appl. No.: 12/343,306

(22) Filed: Dec. 23, 2008

(51) Int. Cl. H04L 9/06

(52) U.S. Cl. 713/189

(57) ABSTRACT

A system and method for developing a software program containing sensitive information requires the use of a developer key (a unique public/private key pair) to download the software onto a uniquely identified developer chip. The software program can then be developed and debugged on the developer chip. After being developed and debugged, the software program is transferred to a uniquely identified release chip for subsequent use. Specifically, transfer of the software program requires use of a release key (also a public/private key pair) that is different from the developer key. The private key part of the developer key, as well as all developer chips (albeit a limited number) are protected by strict security procedures.

### FIELD OF THE INVENTION

The present invention pertains generally to systems and methods for developing and debugging software programs. More particularly, the present invention pertains to systems and methods for developing and debugging software programs containing commercially sensitive information that requires protection from unwanted disclosure. The present invention is particularly, but not exclusively, useful as a system and method that require a unique public/private key pair for developing and debugging a software program on a developer chip, and a uniquely different public/private key pair for release of the developed program onto a release chip for subsequent use.

### BACKGROUND OF THE INVENTION

It frequently happens that software programs will include sensitive information that the developer of the software program would prefer be withheld from public disclosure. Nevertheless, these software programs still need development and, not infrequently, they require debugging when glitches in the program become problematic. During the development and debugging process, the software programs can become particularly vulnerable as access to the sensitive information during the process is necessary. Thus, it is very important that the sensitive information remain somehow protected during the development and debugging of a software program. In particular, it is important to insure that debug code cannot run on production systems.

When a software program is to be used on a silicon chip, the interaction of the software program with the chip is an issue that needs special consideration. Further, the chip itself may incorporate sensitive information that is required for an effective operation of the software program. This is all the more reason why extreme care must be exercised to protect whatever sensitive information may be involved. Thus, in instances where a software program is to be used on a silicon chip, it is necessary to protect the software program, as well as the chip on which it is to be used.

As is well known, public/private key pairs rely on cryptographic algorithms that can be used to protect software content, including creating digital signatures to establish that the software comes from a trusted source. Typically, in a public-key digital signature scheme, the private key is kept secret and is used to create the digital signature, while the public key is publicly available and can be used to verify the digital signature. Importantly, within this public/private key pair it must not be computationally feasible to deduce the private key from the public key. Stated differently, a digital signature can be used to prove that the software came from a source that had access to the (secret) private key. Further, it is well known that public/private key pairs can be used for many different computer software purposes.

In light of the above, it is an object of the present invention to provide a system and method for developing and debugging a software program that protects sensitive information in the software program during its development and debugging. Another object of the present invention is to provide a system and method for developing and debugging a software program that protects sensitive information in a software program after release of the program, as well as during the development and debugging of the program. Still another object of the present invention is to provide a system and method for developing and debugging a software program that provides security for sensitive information by using a public/private key pair (i.e. developer key) for the development and debugging of a software program, while using a different public/private key pair (i.e. a release key) for the release and subsequent use of the software program. Yet another object of the present invention is to provide a system and method for developing and debugging a software program while the software program is downloaded into its intended operational environment (i.e. onto a chip). Another object of the present invention is to provide a system and method for developing and debugging a software program that is easy to manufacture, is simple to use and is comparatively cost effective.

### SUMMARY OF THE INVENTION

A system and method for developing and debugging a software program in accordance with the present invention requires the production of uniquely identified chips, and the controlled use of specific access keys. Importantly, a tightly controlled access key (i.e. developer key) is used to sign the software program so that it can be downloaded onto a uniquely identified developer chip. The developer chip, like the developer key, is also tightly controlled. Once it has been downloaded onto the developer chip, the software program can then be developed and debugged on the developer chip. During the development and debugging process the software program can be repeatedly removed and downloaded as necessary. Then, after the software program has been developed and debugged, a uniquely different access key (i.e. release key) is used to sign the developed software program, which is then downloaded onto a release chip for subsequent use.

For the present invention, both the developer chip and the release chip are produced from a same fabrication chip. The difference between the two is that an electronic latch is activated on the developer chip during its production to identify it as a developer chip. On the other hand, an electronic latch is irreversibly activated on the release chip during its production to identify it as a release chip. It is an important aspect of the present invention that, once a release chip has been produced with its particular electronic latch, the release chip can thereafter never be used as a developer chip [NB: there are other embodiments where this may not be the case (e.g. using flash memory for the latches)]. As intended for the present invention, the electronic latches on the developer chip and on the release chip are each respectively part of a One Time Programmable (OTP) non-volatile memory. With this in mind, it is another important aspect of the present invention that only a limited number of developer chips are produced and, as mentioned above, they are tightly controlled. More specifically, security procedures are used to individually mark each developer chip, and to then inventory and track them so their physical location is known at all times.

Insofar as the access keys are concerned, both the developer key and the release key respectively include their own unique public/private key pair. And, further, the developer key is used to sign versions of the software program that may include code for developing and debugging the software program while it is on the developer chip. For example, such debug code may allow exposure of the secrets within the software and the chip, in order to facilitate development and debugging. The release chip will refuse to run any software program that is not signed with a release key. In particular, the release chip will not run a software program signed with the developer key, so that any security exposure required for debugging can occur only on a developer chip. Along with the security procedures used for protecting the developer chip, access to the private key portion of both the developer and release keys is tightly controlled, so that only authorized personnel can generate software programs that will run on either type of chip.

As envisioned for the present invention, a software program that is to be developed or debugged will include sensitive information that requires protection against disclosure. Further, the chip on which the software is to be run will also likely include sensitive information that requires protection against disclosure. This protection, for both the software and the chip, is typically provided by a cryptographic boundary that is carefully defined and implemented in the software. With this in mind, the present invention develops and debugs software programs containing sensitive information, while the software program is in situ on a developer chip, i.e. while it is in an operational environment similar to the one where it will eventually be used, without compromising security on the release chip.

In operation, a developer chip is selected, and using a digital signature established by a developer key, the software program that is to be developed and debugged is downloaded onto the developer chip. While on the developer chip, the software program can be developed and debugged using debug code that is included in the developer key. As a practical matter, and as noted above, this downloading onto a developer chip can be done repeatedly, as required, to periodically test the software. Once the software program has been satisfactorily developed and debugged, all debug code is removed from the software program, which then goes through a final test phase on the developer chip. A release chip is then selected. Then, using a digital signature established by a release key, the developed software program is transferred onto a release chip for subsequent use.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a schematic presentation of a system used for the present invention;

FIG. 2 is a depiction of the sequential evolution of a fabrication chip into either a developer chip or a release chip;

FIG. 3 indicates the general content of a software program and its conceptual “cryptographic boundary” that is to be developed or debugged in accordance with the present invention;

FIG. 4 indicates the content of a developer key for use with the software program during its development and debugging on a developer chip; and

FIG. 5 indicates the content of a release key for use in releasing the developed software program onto a release chip.

### DESCRIPTION OF THE PREFERRED EMBODIMENTS

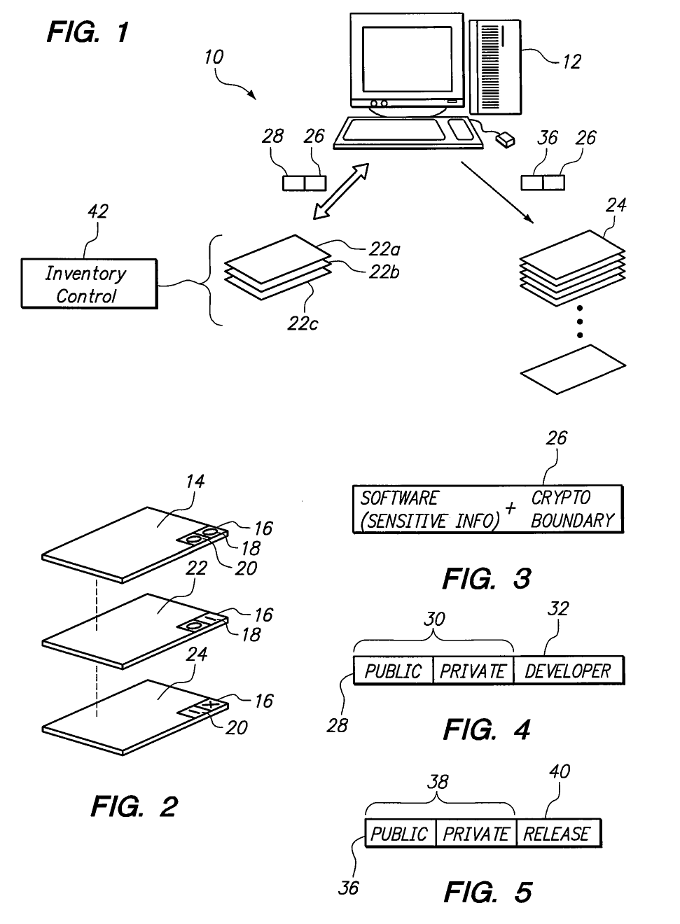

Referring initially to FIG. 1, a system in accordance with the present invention is schematically shown and is generally designated 10. As shown, the system 10 includes a computer 12, or some similar type of a device, that is capable of manipulating and revising (i.e. developing and debugging) computer software. More specifically, as perhaps best appreciated with reference to FIG. 2, the computer 12 is intended to interact with a silicon chip, of a type well known in the pertinent art, such as the silicon fabrication chip 14 shown in FIG. 2. As will be appreciated from the following disclosure, this interaction is for the purpose of developing and debugging a computer software program.

In FIG. 2 it will be seen that a fabrication chip 14 will include an electronic latch 16 that is part of a One Time Programmable (OTP) non-volatile memory. More specifically, as shown in FIG. 2, the electronic latch 16 of the fabrication chip 14 has a global bit 18 and a global bit 20. As shown in FIG. 2, for a fabrication chip 14, the global bit 18 is in a “0” state, and the global bit 20 is also in a “0” state. However, when the global bit 18 of the electronic latch 16 is activated to the “1” state, the fabrication chip 14 is thereby converted into developer chip 22. Further, as shown in FIG. 2, when the global bit 20 of electronic latch 16 is activated to the “1” state, the fabrication chip 14 is converted into a release chip 24. Importantly, activation of the global bit 20 to the “1” state is irreversible. Stated differently, once a release chip 24 has been manufactured, it can never be used thereafter as a developer chip 22.

A software program for use with the system 10 is represented in FIG. 3 and is designated 26. As envisioned for the present invention, the software program 26 will include sensitive information that requires some form of protection from an unwanted or unintentional public disclosure. For this reason, the software program 26 will typically define and implement a cryptographic boundary that specifically provides the necessary security to prevent a public disclosure of the sensitive information. It is to be noted that the developer chip 22, and the release chip 24 may also include sensitive information. If so, the cryptographic boundary in the software program 26 will be structured to protect the sensitive information in both the software program 26 and on the chip 22/24.

An important aspect of the present invention involves the use of a developer key 28. As shown in FIG. 4, the developer key 28 will include a public/private key pair 30 and a developer attribute 32, with the private key used to sign debug code. For purposes of the present invention, the public/private key pair 30 will be of a type well known in the pertinent art, and debug code will include software functions to assist in debugging the software program 26. Further, the developer key 28 will establish a digital signature that electronically identifies the developer key 28. Like the developer key 28, the release key 36 shown in FIG. 5 has a public/private key pair 38 of a type well known in the pertinent art, and a release attribute 40. The release key 36 also establishes a digital signature that electronically identifies the release key 36. Unlike the developer key 28, however, the release key 36 is not used to sign debug code or any similar kind of software function.

Returning now to FIG. 1, it will be seen that for the purposes of the system 10, a plurality of developer chips 22 are created. The developer chips 22a, 22b and 22c are only exemplary. In more detail, the developer chips 22a-c are created, as disclosed above, by activating their respective electronic latches 16. For the present invention, once the plurality of developer chips 22a-c has been created, each developer chip 22 must be protected from public disclosure by physical measures and procedural functions that are collectively referred to herein as inventory control 42. More specifically, this inventory control 42 is envisioned to include unique markings for developer chips 22, as well as inventory accountability and constant monitoring of all developer chips 22 to track their respective physical location at all times. Similar security constraints also need to be placed on any developer private keys 28 that may be created.

In the operation of the system 10 of the present invention, a developer chip 22 is identified and selected. The software program 26 is then downloaded onto the developer chip 22. More specifically, a developer key 28 is used for this purpose, and the digital signature that is established by the developer key 28 is used to complete the download. The developer chip 22 will verify the signature using the developer public key in key pair 30, which is included in the developer chip 22. If the developer signature is not correct, the download is rejected. Once the software program 26 and its sensitive information have been downloaded onto the developer chip 22, the computer 12 can then be used to develop and debug the software program 26. Specifically, this is done by employing debug code in the software program 26. During this process, the software program 26 can be repeatedly re-downloaded onto the developer chip 22, to periodically test the software program 26 as necessary. Once the software program 26 has been developed and debugged, the developer signature with debug code is removed from the software program 26. The release key 36 is then used to sign and transfer the software program 26 onto a release chip 24. The release chip 24 verifies that the software program 26 has been signed with a release key 36. If the signature is not correct, the download is rejected. And, the release chip 24 with a developed software program 26 properly installed can then be forwarded to an end-user (not shown) for subsequent use. Alternatively, the signed released software alone may be sent to a customer who already has a release chip 24 in his system, perhaps running older version(s) of the release software.

While the particular System and Method for Developing Computer Chips Containing Sensitive Information as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A system for creating a software program, wherein the software program includes sensitive information protected by a cryptographic boundary, the system comprising:
a developer chip formed with a means for fixing its unique identification as a developer chip, wherein the software program, with its sensitive information, is downloaded onto the developer chip for developing and debugging the software on the developer chip; and
a release chip formed with a means for fixing its unique identification as a release chip and for preventing its use as a developer chip, wherein, after development and debugging of the software on the developer chip, the software program with its sensitive information is transferred to the release chip for use of the software.

2. A system as recited in claim 1 wherein the identification fixing means of the developer chip and the identification fixing means of the release chip are each part of a One Time Programmable (OTP) non-volatile memory.

3. A system as recited in claim 1 wherein the developer chip and the release chip have a same silicon structure.

4. A system as recited in claim 1 wherein downloading the software onto the developer chip requires use of a digital signature established by a developer key.

5. A system as recited in claim 4 wherein the developer key includes debug code for developing and debugging the software.

6. A system as recited in claim 4 wherein transferring the software to the release chip requires use of a digital signature established by a release key.

7. A system as recited in claim 6 wherein the developer key is a private/public key pair, and wherein the release key is a private/public key pair.

8. A system as recited in claim 1 wherein a predetermined plurality of developer chips are created.

9. A system as recited in claim 8 wherein each developer chip is individually marked, inventoried, and monitored to track its physical location at all times.

10. A system as recited in claim 1 wherein the developer chip and the release chip each include sensitive information to be protected by the cryptographic boundary in the software.

11. A system for developing and debugging a software program wherein the software program includes sensitive information protected by a cryptographic boundary, the device comprising:
a developer key for downloading the software program, with its sensitive information, onto a developer chip, wherein the developer key signs code to develop and debug the software program and its sensitive information on the developer chip, and further wherein the developer chip has an electronic latch activated to identify it as a developer chip; and
a release key for signing the developed and debugged software program, and its sensitive information, to download the software program to a release chip for use of the software program, wherein the release chip has an electronic latch irreversibly activated to prevent its use as a developer chip.

12. A system as recited in claim 11 wherein the release chip and the developer chip have a same silicon structure.

13. A system as recited in claim 11 wherein the electronic latch on the developer chip is part of a One Time Programmable (OTP) non-volatile memory, and the electronic latch on the release chip is part of a One Time Programmable (OTP) non-volatile memory.

14. A system as recited in claim 11 wherein the developer key is a private/public key pair and the release key is a private/public key pair.

15. A system as recited in claim 14 wherein each developer chip is individually marked, inventoried, and monitored to track its physical location at all times.

16. A method for creating a software program wherein the software program includes sensitive information protected by a cryptographic boundary, the method comprising the steps of:
identifying at least one developer chip and at least one release chip by activating an electronic latch to identify the developer chip, and by irreversibly activating an electronic latch to prevent use of the release chip as a developer chip;
downloading the software program with its sensitive information onto the developer chip;
employing debug code to develop and debug the software program and its sensitive information on the developer chip;
removing the debug code from the software program, after the employing step;
testing the software program on the developer chip, after the removing step;
repeating the employing step, the removing step, and the testing step in sequence, if necessary; and
transferring the developed and debugged software to the release chip for use of the software program.

17. A method as recited in claim 16 further comprising the steps of:
using a digital signature established by a developer key to accomplish the downloading step, wherein the developer key is a private/public key pair;
using a digital signature established by a release key to accomplish the transferring step, wherein the release key is a private/public key pair; and
protecting the respective private keys of the developer key and the release key.

18. A method as recited in claim 16 wherein the electronic latch on the developer chip is part of a One Time Programmable (OTP) non-volatile memory, and the electronic latch on the release chip is part of a One Time Programmable (OTP) non-volatile memory.

19. A method as recited in claim 18 wherein the developer chip and the release chip have a same silicon structure.

20. A method as recited in claim 16 further comprising the steps of:
uniquely marking each developer chip in a plurality of developer chips;
inventorying the plurality of developer chips; and
monitoring each developer chip to track its physical location at all times.
